(19) United States
(12) Patent Application Publication
(10) Pub. No.: US 2010/0103661 A1
(43) Pub. Date: Apr. 29, 2010

(54) Machine Vision Inspection System and Light Source Module thereof

(76) Inventors: Yih-Chih Chiou, Hsinchu (TW); Jian-Zong Liu, Hsinchu (TW)

Correspondence Address: LanWay IPR Services, P.O. box 223205, Chantilly, VA, 20153, US

(21) Appl. No.: 12/352,868

(22) Filed: Jan. 13, 2009

(30) Foreign Application Priority Data
Oct. 27, 2008 (TW) 097141251

(51) Int. Cl. F21V 9/08

(52) U.S. Cl. 362/231

(57) ABSTRACT

In a machine vision inspection system and a light source module, the light source module includes a semi-cylindrical lampshade and linear LED light sources for provide light beams. The luminance is determined by a number of rows of the linear LED light sources, a length of each linear LED light source and cooperation of colors, wavelengths or sizes of the LEDs. The linear LED light sources are located or assembled to an interior of a curved surface of the semi-cylindrical lampshade, and arranged from a first curved-surface edge to a second curved-surface edge of the curved interior by a preset interval and a relative included angle. An arranging direction of the linear LED light sources is same to an extending direction of the interior of the curved interior. The shadow caused by illuminating from one single side may be eliminated. The present invention possesses the advantage of low cost.

### BACKGROUND

1. Field of the Invention

The present invention relates to a machine vision inspection system and a light source module thereof, and more particularly to a light source module having adjustable linear light emitting diode (LED) light sources with high and uniform luminance and to an inspection system using the same.

2. Description of the Related Art

Currently, common light sources applied into a machine vision inspection system include halogen lamp, fluorescence lamp, xenon lamp, LED and laser, etc. Since the LED has many advantages, such as long lifetime (about 20,000 hours), low power consumption, fast response-time, low probability of damage and low cost, etc., the LED has been widely used in the machine vision inspection system and has gradually replaced other light sources to be a main-trend of the market. LED lighting devices mainly include spot lighting device, linear lighting device, bar lighting device, light-condensing bar lighting device, square lighting device, ring lighting device, flat-surface lighting device and dome lighting device. The above-mentioned LED lighting devices, except the bar lighting device, the line lighting device and the light-condensing bar lighting device are designed for the automatic optical inspection system based on the area-scan camera.

As described in the above, the bar, line and light-condensing bar LED lighting devices are applicable to automatic optical inspection systems based on line scan cameras, inspection systems based on machine vision techniques, or image grabbing systems based on line scan cameras. The linear lighting device includes two categories, one is the array LED lighting device and the other is the halogen lamp with linear fiber optic light guide. The common array LED lighting device is further classified into the line type LED and the bar type LED. Furthermore, to enable the bar type LED lighting device consisted of at least two rows of LEDs to condense the light beams, a light-condensing lens is generally assembled in the front of the bar type LED lighting device (that is, the outlet of the bar type LED lighting device). Such that, the bar type LED lighting device is assembled to be the so-called light-condensing bar type LED lighting device. In addition, if the array LED light source is consisted of high-luminance LEDs, the whole luminance of the light source can be improved. However, when designing an array LED light source consisted of high-luminance LEDs; it must take into account many problems such as the uniformity of the light source, the heat dissipation, and the lifetime, etc. It should be noted that the halogen lamp with linear fiber optic light guide is substantially similar to the light-condensing bar type LED lighting device, except that the light beams to the fiber optic light guide is provided by the halogen lamp instead of the LEDs. The light beams emitted from the halogen lamp are transmitted to a linear outlet of the fiber optic through the fiber optic light guide. For focusing the light beams on a line, the linear fiber optic light guide generally cooperates with a light-condensing lens. In general, using the linear fiber optic light guide can provide the light beams with high luminance, but the costs of the halogen lamp and the light-condensing lens are relatively high.

In summary, the conventional linear lighting devices have the disadvantage of poor luminance and are difficult to be assembled. The halogen lamp with linear fiber optic light guide has the disadvantage of high cost. In detail, the line type array LED lighting device has the disadvantage of the poor luminance. The bar type array LED lighting device has the disadvantage of being difficult to focus the light beams. The light-condensing bar type LED lighting device and the linear fiber optic light guide must be used with the expensive light-condensing lens. The halogen lamp consumes more power (the power consumed by the halogen lamp is about five times of that of the LED) and has a short lifetime (about 2000 hours, and one-tenth of that of the LED). In addition, no matter which of the above-mentioned lighting devices is employed, when shadow appears in the grabbed image, a common approach to eliminate the shadow is to arrange another same lighting device in the symmetric side. However, it will increase the cost and generate a new problem of how to accurately arrange the lighting device in the symmetrical side. Therefore, what is needed is developing an adjustable linear LED light source module with high and uniform luminance and an inspection system using the same.

### BRIEF SUMMARY

The present invention relates to a machine vision inspection system, which grabs images of an object under test in enough and uniform luminance by linear image capture module to generate images, and of which the light source module is adjustable.

The present invention also relates to a light source module configured for providing linear LED light sources for a linear image capture module, and the linear LED light sources is adjustable, capable of providing light beams with enough and uniform luminance, and easily to be assembled and replaced.

The present invention also relates to a light source module, which employs a semi-cylindrical lampshade to locate or assemble linear LED light sources therein for providing light beams for a linear image capture module, wherein the linear LED light sources are capable of providing light beams with enough luminance and easily to be assembled and replaced, and the projecting-angle of the linear LED light sources is adjustable.

A machine vision inspection system in accordance with the present invention comprises an inspection stage, a linear image capture module and a light source module. The inspection stage is configured for moving the object under test. The linear image capture module is configured for grabbing images of the object under test. The light source module comprises a plurality of linear LED light sources and a lampshade, and the light source module is configured for providing light beams to the linear image capture module. Each of the linear LED light sources comprises a plurality of LEDs. Furthermore, luminance of the linear LED light sources is determined by the number of rows of the linear LED light sources, the length of each of the linear LED light sources and the cooperation of the LEDs with the same or different colors, wavelengths or sizes. The lampshade has a semi-cylindrical inner space. The interior of the lampshade is a semi-circular curved surface with an upward opening or a downward opening, and includes a first disposing area and a second disposing area. The linear LED light sources are disposed symmetrically in the first disposing area and the second disposing area. Intervals between each two adjacent linear LED light sources in the first disposing area and the second disposing area are the same. The linear field of view of the linear image capture module is served as a reference axis, and each of the linear LED light sources is disposed at a relative included angle relative to the reference axis. The arranging direction of each of the linear LED light sources is the same with an extending direction of the semi-circular curved surface.

In an embodiment of the present invention, the interior shape of the lampshade is semi-cylindrical, and the exterior shape of the lampshade may be the same or different from the interior shape of the lampshade. Material of the interior of the lampshade or coating on the interior of the lampshade can comprise plastic or metal which may be capable of reflecting light, absorbing light or dissipating heat in order to condense or expand the light beams. Furthermore, the linear LED light sources may be assembled or replaced to the lampshade from the interior or the exterior by a combining means, such as locking or wedging, etc. Furthermore, angle-adjusting elements may be employed to adjust the arranging angles of the linear LED sources and the illuminating locations of the light beams illuminating the linear field of view.

A light source module in accordance with the present invention is configured for providing light beams to a linear image capture module and comprises a plurality of linear LED light sources and a lampshade. The linear LED light sources are configured for providing the light beams according to a preset illuminating-direction. Each of the linear LED light sources comprises a plurality of LEDs. Luminance of the linear LED light sources is determined by the number of rows of the linear LED light sources, the length of each of the linear LED light sources and the cooperation of the LEDs with the same or different colors, wavelengths or sizes. The interior of the lampshade is a semi-circular curved surface with an upward opening or a downward opening, and has a first disposing area and a second disposing area. The linear LED light sources are disposed in the first disposing area and the second disposing area. Intervals between each two adjacent linear LED light sources in the first disposing area and the second disposing area are the same, and each of the linear LED light sources is disposed at a relative included angle. An arranging direction of each of the linear LED light sources is the same with an extending direction of the semi-circular curved surface.

In an embodiment of the present invention, the light source module may be joined to the lampshade from the exterior or interior of the lampshade by a plurality of combining grooves or a combining means. The combining means may be locking, wedging, clasping, embedding, welding, adhering and magnetism-combining or assembling lock portions, etc. Furthermore, the preset illuminating-direction may be projecting and focusing the light beams provided by the linear LED light sources to the linear field of view of the linear image capture module, projecting the light beams provided by each or a part of the linear LED light sources at one or more specific angles, and projecting the light beams provided by the linear LED light sources to the interior of the lampshade for being reflected by the interior of the lampshade to at least one specific focus or being absorbed.

A light source module in accordance with the present invention is applied into a linear image capture system and comprises a plurality of linear LED light sources and a semi-cylindrical lampshade. The linear LED light sources are configured for providing light beams, and each of the linear LED light sources comprises a plurality of LEDs. Luminance of the linear LED light sources is determined by the number of rows of the linear LED light sources, the length of each of the linear LED light sources and the cooperation of the LEDs with the same or different colors, wavelengths or sizes. The linear LED light sources are located or assembled to the curved interior of the semi-cylindrical lampshade and are symmetric to the longitudinal axis of the semi-cylindrical lampshade. The linear LED light sources are arranged from the first edge of the curved-surface of the curved interior to the second edge of the curved-surface of the curved interior by a preset interval and a preset relative included angle, and the arranging direction of each of the linear LED light sources is the same as the extending direction of the curved interior.

In an embodiment of the present invention, the semi-cylindrical lampshade of the light source module has a first removable portion located at the edge of the first curved-surface and a second removable portion located at the edge of the second curved-surface for preventing the semi-cylindrical lampshade from touching the object under test. In addition, the intervals between each two adjacent linear LED light sources and the preset relative included angles of the linear LED light sources are the same or different according to a preset illuminating-direction.

The present invention employs the machine vision inspection system and the light source module to enable each LED and the linear LED light sources assembled to the lampshade to be adjustable by the angle-adjusting elements for illuminating rightly onto the linear field of view of a linear image capture device such as a line scan camera. Since the distances from each LED to the linear field of view or from the linear LED light sources to the linear field of view may be designed to be the same or different, the luminance of the light source module can be uniform, consistent, or different. Furthermore, since the LED light sources illuminate from both sides of the longitudinal axis of the semi-cylindrical lampshade, the shadow effect can be avoided. In addition, compared with the halogen lamp, the present invention consumes less power, produces less heat, has a long lifetime and provides more concentrated light beams with high luminance. In addition, the light source module of the present invention may be an independent unit, is easy to use and free from complex adjusting procedures, thus it can be used widely. Furthermore, the product cost of the present invention is relatively lower than the array LED lighting device having the light-condensing lens and the halogen lamp with linear fiber optic light guide having the light-condensing lens.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1A is a three dimensional view of a machine vision inspection system in accordance with an embodiment of the present invention.

FIG. 1B is an exploded view of a light source module of the machine vision inspection system in accordance with an embodiment of the present invention.

FIG. 1C is an exploded view of a light source module of a machine vision inspection system in accordance with another embodiment of the present invention.

FIG. 2A is a cross-sectional view of a light source module in accordance with an embodiment of the present invention.

FIG. 2B is a three dimensional view of a light source module in accordance with another embodiment of the present invention.

FIG. 3 is a cross-sectional and exploded view of a light source module in accordance with an embodiment of the present invention.

### DETAILED DESCRIPTION

Reference will now be made to the drawings to describe exemplary embodiments of the present machine vision inspection system, in detail. The following description is given by way of example, and not limitation.

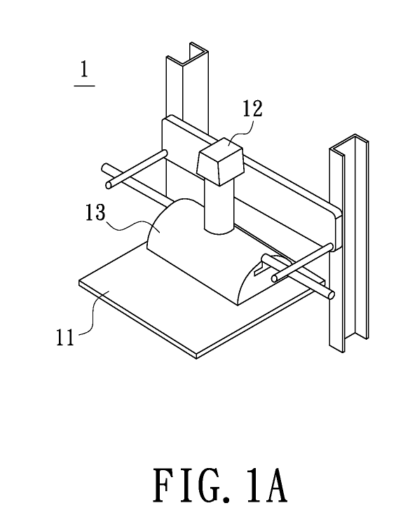

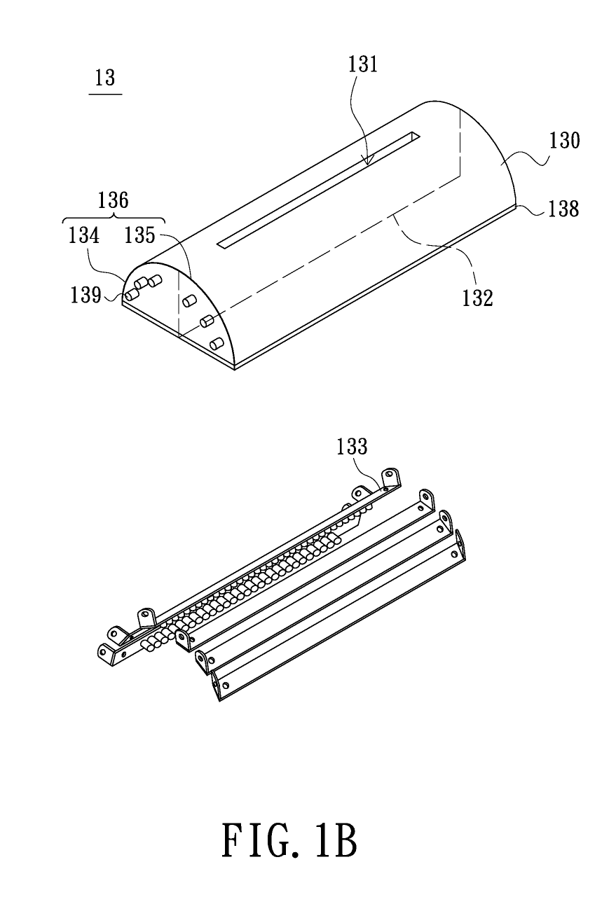

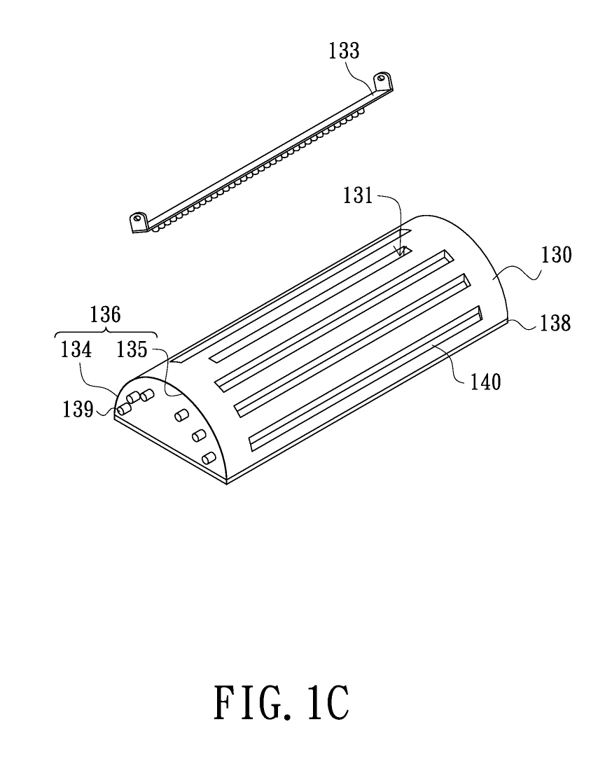

FIG. 1A is a three dimensional view of a machine vision inspection system in accordance with an embodiment of the present invention. As shown in FIG. 1A, the inspection system 1 includes an inspection stage 11, a linear image capture module 12 configured for grabbing images, and a light source module 13. The inspection stage 11 is configured for moving an object under test. The linear image capture module 12 cooperates with the moving of the inspection stage 11 and the light source module 13 to pick up the images of the object under test from a linear field of view of the linear image capture module 12.

FIG. 1B is an exploded view of the light source module of the machine vision inspection system in accordance with an embodiment of the present invention. As shown in FIG. 1B, the light source module 13 comprises a lampshade 130 and a plurality of linear LED light sources 133. The lampshade 130 has a semi-cylindrical inner space. The exterior of the lampshade 130 may be a semi-cylindrical and similar to an interior of the lampshade 130, or may be other shapes. Furthermore, in this embodiment, the interior of the lampshade 130 is a semi-circular curved surface 136 with a downward opening. A first disposing area 134 and a second disposing area 135 are arranged at both sides of the longitudinal axis 132 of the semi-cylindrical lampshade. The linear LED light sources 133 are located symmetrically in the first disposing area 134 and the second disposing area 135. Intervals between each two adjacent linear LED light sources 133 in the first disposing area 134 and the second disposing area 135 are the same. The linear field of view of the linear image capture module 12 is served as a reference axis, wherein the linear field of view means a linear area where the images of the object under test will be captured before each movement of the object under test and is not shown in FIG. 1B. Each of the linear LED light sources 133 is disposed at a relative included angle (such as 22.5 degrees) relative to the reference axis, and an arranging direction of each of the linear LED light sources 133 is the same with an extending direction of the semi-circular curved surface 136. Furthermore, angle-adjusting elements 139 may be employed to adjust the arranging angles of the linear LED light sources 133 for adjusting illuminating angles and illuminating locations of the light beams illuminating the linear field of view. In addition, each of the linear LED light sources 133 has at least one row of LEDs arranged thereon. The number of the LEDs in each row may be increased or decreased according to the width of the object under test. Furthermore, the luminance of the linear LED light sources 133 may be adjusted by increasing or decreasing the number of rows of the LEDs of each of the linear LED light sources 133, and be determined by the cooperation of the LEDs with the same or different colors, wavelengths or sizes. For example, red LEDs with wavelength within 622 nm and 625 nm (not limited in this wavelength), φ5 and 20 mA are employed or RGB combined LEDs are employed for emitting a variety of colors light beams. In addition, the length and the width of the linear LED light sources 133 or the whole light source module 13 may be expanded and contracted or selected to determine the luminance of the linear LED light sources 133. The material of the lampshade 130 may comprise plastic such as acrylic plastic or metal such as steel or aluminum with better heat-dissipating capacity. The material of the interior of the lampshade 130 or the coating on the interior of the lampshade 130 may be silver and so on which is capable of reflecting light, absorbing light or dissipating heat to improve the light-reflecting capability of the object under test, such that the luminance of the light source module 13 can be improved. Furthermore, a suitable heat-dissipating fan may be used to solve the heat-dissipating problem generated by the LEDs with high-luminance. In addition, the size or the length of the lampshade 130 may be expanded and contracted according to the size or the product cost of the inspection system. In another embodiment, a removable portion 138 may be joined to the lampshade 130 by a slide track. The removable portion 138 configured for being removed can be removed to avoid touching the object under test or to respond to inspect the object under test with irregular or curved-shaped. Therefore, the light beams may still be focused on the linear field of view of the linear image capture module 12 without requiring adjusting the illuminating angles of the linear LED light sources 133.

Please refer to FIGS. 1B and 1C, wherein FIG. 1C is an exploded view of the light source module of the machine vision inspection system in accordance with another embodiment of the present invention. In this embodiment, a plurality of assembling lock portions (covered by the angle-adjusting elements 139) for attaching the linear LED light sources 133 to the lampshade 130 are arranged in the both sides of the lampshade 130 according to the arc-length and the radian of the semi-circular curved surface 136 or the width of the carrier of the linear LED light sources 133. Alternatively, the linear LED light sources 133 may be joined to the lampshade 130 from the interior of the lampshade 130 or the exterior of the lampshade 130 by any assembly means, such as wedging, clasping, embedding, welding, adhering or magnetism-combining. As shown in FIG. 1C, the lampshade 130 has combining grooves 140 disposed at the first disposing area 134 and the second disposing area 135 for joining the linear LED light sources 133 to the lampshade 130 from the exterior of the lampshade 130. It should be noted that the lampshade 130 of the embodiments as shown in FIGS. 1A to 1C may has an observation window 131 which can be a rectangular opening in actual, such that the linear image capture module 12 can see and grab images of the object under test therefrom. However, if the semi-circular curved surface of the lampshade 130 having an upward opening, since the linear LED light sources 133 provide the light beams to the semitransparent object under test in a back projection mode, the observation window 131 is not needed.

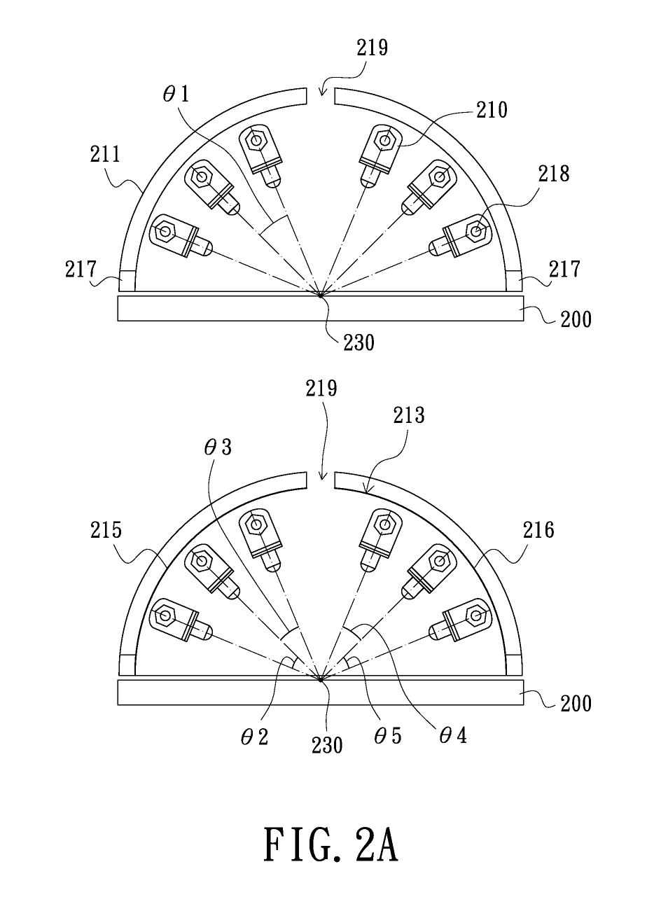

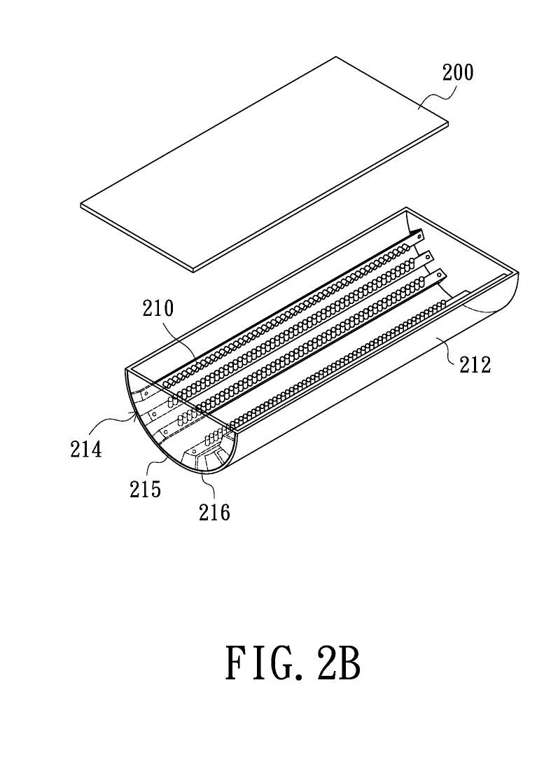

FIGS. 2A and 2B are a cross-sectional view and a three dimensional view of the light source module in accordance with two embodiments of the present invention respectively. As shown in FIG. 2A, the light source module 2 is configured for providing light beams to a linear image capture module and includes a plurality of linear LED light sources 210 and a lampshade 211. In order to describe clearly, the lampshade as shown in FIG. 2B is indicated by a numeral 212. The carrier of the linear LED light sources 210 may be a rigid or flexible circuit board. The size of the circuit board is determined by the actual width and size of the object under test or the LEDs. The flexible circuit board can make each of the linear LED light sources 210 be closer to the semi-circular curved surface, such that the precision of the illuminating angle is improved. The linear LED light sources 210 provide the light beams according to a preset illuminating-direction, and the luminance of the linear LED light sources 210 is determined by the length of each of the linear LED light sources 210, the number of rows of the linear LED light sources 210, and the cooperation of the LEDs with the same or different colors, wavelengths or sizes. Furthermore, the preset illuminating-direction may be projecting and focusing the light beams provided by the linear LED light sources 210 to the linear field of view 230 of the linear image capture module, projecting the light beams provided by all or a part of the linear LED light sources 210 to one or more specific angles, or projecting the light beams provided by the linear LED light sources 210 to the interior of the lampshade 211/212 to be reflected to at least one specific focus or be absorbed.

In the above-mentioned embodiments, the interior and the exterior of the lampshade 211/212 may be semi-cylindrical, and the exterior of the lampshade 211/212 also may be other shapes. The material of the lampshades 211/212 may comprise plastic or metal, etc. There is a coating disposed at the interior of the lampshade 211/212, wherein the coating is capable of reflecting light, absorbing light or dissipating heat. In addition, the interior of the lampshade 211/212 may be a semi-circular curved surface 213 with a downward opening or a semi-circular curved surface 214 with an upward opening. Furthermore, a first disposing area 215 and a second disposing area 216 are arranged at both sides of the longitudinal axis of the semi-cylindrical lampshade 211/212. Each of the linear LED light sources 210 are located in the first disposing area 215 and the second disposing area 216 at a same interval and a same relative included angle relative to the reference axis, and an arranging direction of the linear LED light sources 210 is the same with an extending direction of the semi-circular curved surface 213/214. In other words, the linear LED light sources 210 are arranged substantially in parallel.

In the above-mentioned embodiments, the linear LED light sources 210 are attached to the lampshade 211/212 by a combining means, such as locking, wedging, clasping, embedding, welding, adhering and magnetism-combining. Therefore, in an embodiment, the combining means may employ the assembling lock portions (not shown in FIGS. 2A and 2B) arranged at the lampshade 211/212. In another embodiment, there are the combining-grooves (not shown in FIGS. 2A and 2B) disposed in the first disposing area 215 and the second disposing area 216 of the lampshades 211/212 to attach the linear LED light sources 210 to the lampshade 211/212 from the exterior of the lampshade 211/212. In addition, in another embodiment, the lampshade 211 may have a removable portion 217 located therein.

Referring to FIG. 2A again, the relative included angle 01 of each of the linear LED light sources 210 may be a constant value, such as 22.5 degrees. Furthermore, the lampshade 211 may have an observation window 219, such that the linear image capture module can see and grab the images of the linear field of view 230 of the object under test 200 therefrom. However, for the lampshade 212 of the semi-circular curved surface 214 with the upward opening (shown in FIG. 2B), the object under test 200 may be arranged in the front of the lampshade 212, and the linear LED light source 210 can provide the light beams to the semitransparent object under test in a backlighting method. Thus, the observation window 219 is not needed. Furthermore, in a condition of avoiding the lampshade directly contacting the object under test 200 or in a condition that the lampshade has the upward opening and uses the backlighting mode, the angle-adjusting elements 218 are employed to adjust the linear LED light sources 210. Such that, the preset illuminating-direction is determined for rightly projecting the light beams provided by the linear LED light sources 210 to the needed location, orientation or the linear field of view 230. For example, the relative included angles θ2 and θ5 as shown in FIG. 2A are 19.3 degrees, the relative included angles θ3 and θ4 are 19.6 degrees, and the relative included angles at the both sides of the linear field of view 230 are 20.3 degrees. The relative included angles are all designed to be symmetrical. Alternatively, the relative included angles may be adjusted to be asymmetrical.

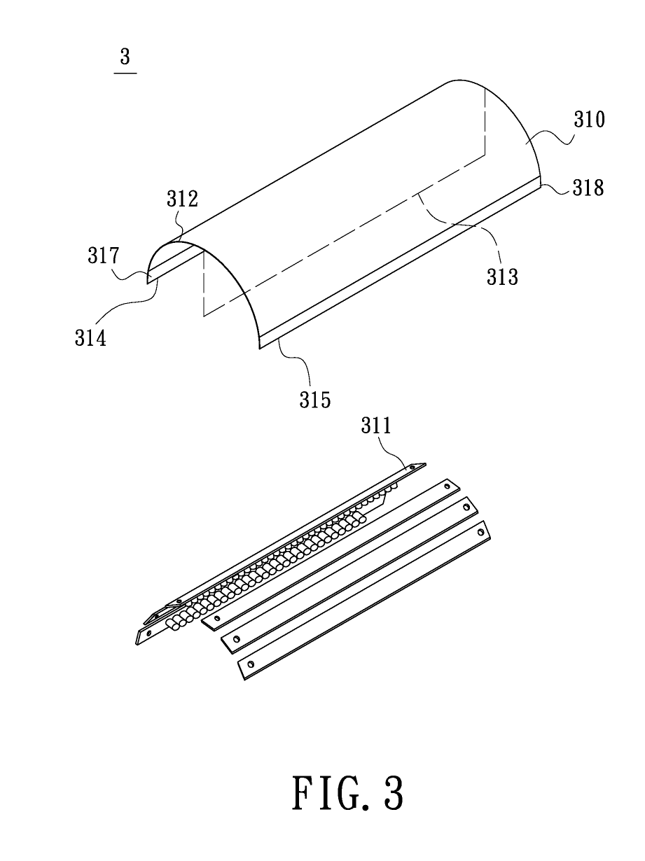

FIG. 3 is a cross-sectional and exploded view of the light source module in accordance with another embodiment of the present invention. As shown in FIG. 3, the light source module 3 may be configured for providing light beams to a linear image capture module and comprise a semi-cylindrical lampshade 310 and a plurality of linear LED light sources 311. The semi-cylindrical lampshade 310 is configured for locating or assembling the linear LED light sources 311 in the interior of the curved surface 312 of the semi-cylindrical lampshade 310 and the linear LED light sources 311 are symmetric to the longitudinal axis 313 of the semi-cylindrical lampshade. Furthermore, the linear LED light sources 311 are arranged from the first edge of the curved-surface 314 of the curved interior 312 to the second edge of the curved-surface 315 of the curved interior 312 at a preset interval and a preset relative included angle, and the arranging direction of the linear LED light sources 311 is the same as the extending direction of the curved interior 312. The semi-cylindrical lampshade 310 may be made of plastic or metal, etc., and the interior of the semi-cylindrical lampshade 310 may be coated with a coating capable of reflecting light, absorbing light or dissipating the heat.

The linear LED light sources 311 may be joined to the lampshade 310 by the combining means such as locking, wedging, clasping, embedding, welding, adhering and magnetism-combining, etc. For example, the linear LED light sources 311 may be attached to the lampshade 310 from the exterior of the lampshade 310 by combining grooves (not shown in FIG. 3). Furthermore, the luminance of the linear LED light sources 311 is determined by the length of each of the linear LED light sources 311, the number of the rows of the LEDs of each of the linear LED light sources 311, and the cooperation of the LEDs with the same or different colors, wavelengths, or sizes. It should be noted that, the normal direction of each point of the semi-cylindrical lampshade 310 points to the longitudinal axis 313 of the semi-cylindrical lampshade, such that the light beams provided by each LED assembled on the semi-cylindrical lampshade 310 are focused in the same line (that is the linear field of view of the linear image capture module). Since the perpendicular distances from each point of the lampshade 310 to the linear field of view are equal, the luminance of the linear field of view provided by each LED is the same, such that the linear field of view is illuminated uniformly. That is, the luminance of each point in the linear field of view is the same. In addition, in another embodiment, the light-condensing capability of the light sources may be enhanced or weakened according to the properties of the object under test. Therefore, the space and the relative included angle between any two adjacent linear LED light sources 311 may be the same or the different according to a preset illuminating-direction for adjusting the luminance.

Furthermore, the semi-cylindrical lampshade 310 may has a first removable portion 317 and a second removable portion 318 arranged at the edge of the first curved-surface 314 and the edge of the second curved-surface 315 respectively. The first removable portion 317 and the second removable portion 318 can be removed for preventing the semi-cylindrical lampshade 310 from touching the object under test.

For providing the linear image capture module to grab images of the object under test, an observation window (not shown in FIG. 3) is arranged in the semi-cylindrical lampshade 310 which has the curved interior 312 with the downward opening, such that the linear image capture module can grab images of the object under test. Furthermore, in another embodiment, the light source module 3 can further comprise angle-adjusting elements (not shown in FIG. 3) such as knobs. The angle-adjusting elements are configured to be operated by users to adjust the illuminating-angles of the linear LED light sources 311 from the exterior of the semi-cylindrical lampshade 310.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A machine vision inspection system, comprising:
an inspection stage configured for moving an object under test;
a linear image capture module configured for grabbing an image of the object under test; and
a light source module configured for providing light beams to the linear image capture module, and the light source module comprising:
a plurality of linear light emitting diode (LED) light sources configured for providing the light beams, each of the linear LED light sources comprising a plurality of LEDs, luminance of the linear LED light sources being determined by the number of rows of the linear LED light sources, the length of each of the linear LED light sources and the cooperation of the LEDs with the same or different colors, wavelengths or sizes; and
a lampshade having a semi-cylindrical inner space, the interior of the lampshade being a semi-circular curved surface with an upward opening or a downward opening, a first disposing area and a second disposing area in the interior of the lampshade being located at both sides of the longitudinal axis of the semi-cylindrical lampshade, the linear LED light sources being disposed symmetrically in the first disposing area and the second disposing area, intervals between each two adjacent linear LED light sources in the first disposing area and the second disposing area being the same, a linear field of view of the linear image capture module being served as a reference axis, each of the linear LED light sources being disposed at a relative included angle relative to the reference axis, and an arranging direction of each of the linear LED light sources being the same with an extending direction of the semi-circular curved surface.

2. The machine vision inspection system as claimed in claim 1, wherein the exterior of the lampshade is semi-cylindrical, material of the lampshade comprises plastic or metal, and material of the interior of the lampshade or a coating on the interior of lampshade is capable of reflecting light, absorbing light or dissipating heat, and a size or a length of the lampshade is expandable and contractible.

3. The machine vision inspection system as claimed in claim 1, wherein the lampshade has a plurality of combining grooves disposed at the first disposing area and a second disposing area for attaching the linear LED light sources to the lampshade from the exterior of the lampshade.

4. The machine vision inspection system as claimed in claim 1, wherein the linear LED light sources are joined to the lampshade by a combining means.

5. The machine vision inspection system as claimed in claim 4, wherein the combining means is selected from a group consisting of locking, wedging, clasping, embedding, welding, adhering and magnetism-combining.

6. The machine vision inspection system as claimed in claim 1, wherein the lampshade has a removable portion located at a contact location between the lampshade and the object under test for avoiding the lampshade contacting the object under test.

7. The machine vision inspection system as claimed in claim 1, wherein the lampshade further comprises:
a plurality of angle-adjusting elements configured for adjusting arranging angles of the linear LED light sources to adjust illuminating angles and illuminating locations of the light beams illuminating the linear field of view.

8. A light source module for providing light beams to a linear image capture module, comprising:
a plurality of linear LED light sources configured for providing the light beams according to a preset illuminating-direction, each of the linear LED light sources comprising a plurality of LEDs, luminance of the linear LED light sources being determined by the number of rows of the linear LED light sources, the length of each of the linear LED light sources and the cooperation of the LEDs with the same or different colors, wavelengths or sizes; and
a lampshade, the interior shape of the lampshade being a semi-circular curved surface with an upward opening or a downward opening and having a first disposing area and a second disposing area, the linear LED light sources being disposed in the first disposing area and the second disposing area, intervals between each two adjacent linear LED light sources in the first disposing area and the second disposing area being the same, each of the linear LED light sources being disposed at a relative included angle, and an arranging direction of each of the linear LED light sources being the same with an extending direction of the semi-circular curved surface.

9. The light source module as claimed in claim 8, wherein the exterior shape of the lampshade is semi-cylindrical.

10. The light source module as claimed in claim 8, wherein the lampshade has a plurality of combining grooves disposed at the first disposing area and the second disposing area for combining the linear LED light sources with the lampshade from an exterior of the lampshade.

11. The light source module as claimed in claim 8, wherein the linear LED light sources are attached to the lampshade by a combining means.

12. The light source module as claimed in claim 11, wherein the combining means is selected from a group consisting of locking, wedging, clasping, embedding, welding, adhering and magnetism-combining.

13. The light source module as claimed in claim 11, wherein the combining means employs assembling lock portions arranged at the lampshade.

14. The light source module as claimed in claim 8, wherein the lampshade further comprises a removable portion configured for preventing the lampshade from touching the object under test.

15. The light source module as claimed in claim 8, wherein the lampshade further comprises:
a plurality of angle-adjusting elements configured for adjusting the linear LED light sources to determine the preset illuminating-direction.

16. The light source module as claimed in claim 8, wherein the preset illuminating-direction is selected from a group consisting of projecting and focusing the light beams provided by the linear LED light sources to a linear field of view of the linear image capture module, projecting the light beams provided by all of the linear LED light sources or a part of the linear LED light sources at one or more specific angles and projecting the light beams provided by the linear LED light sources to the interior of the lampshade for being reflected by the interior of the lampshade to at least one specific focus or being absorbed.

17. The light source module as claimed in claim 8, wherein a carrier of each of the linear LED light sources is a rigid or flexible circuit board.

18. The light source module as claimed in claim 8, wherein material of the lampshade comprises plastic or metal, and the interior of the lampshade is coated with a coating capable of reflecting light, absorbing light or dissipating heat.

19. A light source module for a linear image capture system, comprising:
a plurality of linear LED light sources configured for providing light beams, each of the linear LED light sources comprising a plurality of LEDs, luminance of the linear LED light sources being determined by the number of rows of the linear LED light sources, the length of each of the linear LED light sources and the cooperation of the LEDs with the same or different colors, wavelengths or sizes; and
a semi-cylindrical lampshade, the linear LED light sources being located at or assembled to the curved interior of the semi-cylindrical lampshade and being symmetric to the longitudinal axis of the semi-cylindrical lampshade, the linear LED light sources being arranged from the edge of the first curved-surface of the curved interior to the edge of the second curved-surface of the curved interior by a preset interval and a preset relative included angle, and an arranging direction of each of the linear LED light sources being the same with an extending direction of the curved interior.

20. The light source module as claimed in claim 19, wherein the semi-cylindrical lampshade further comprises:
a plurality of combining grooves configured for attaching the linear LED light sources to the semi-cylindrical lampshade from an exterior of the lampshade.

21. The light source module as claimed in claim 19, wherein the linear LED light sources are joined to the semi-cylindrical lampshade by a combining means, and the combining means is selected from a group consisting of locking, wedging, clasping, embedding, welding, adhering and magnetism-combining.

22. The light source module as claimed in claim 19, wherein the semi-cylindrical lampshade has a first removable portion located at the edge of the first curved-surface and a second removable portion located at the edge of the second curved-surface for preventing the semi-cylindrical lampshade from touching the object under test.

23. The light source module as claimed in claim 19, wherein the semi-cylindrical lampshade further comprises:
a plurality of angle-adjusting elements for adjusting illuminating-angles of the linear LED light sources.

24. The light source module as claimed in claim 19, wherein material of the semi-cylindrical lampshade comprises plastic or metal, and the curved interior of the semi-cylindrical lampshade is coated with a coating capable of reflecting light, absorbing light or dissipating heat.

25. The light source module as claimed in claim 19, wherein intervals between each two adjacent linear LED light sources and the preset relative included angles of the linear LED light sources are the same or different according to a preset illuminating-direction.
